(19) United States
(12) Patent Application Publication
(10) Pub. No.: US 2009/0280206 A1
(43) Pub. Date: Nov. 12, 2009

(54) MACHINE FOR BLOW-MOULDING CONTAINERS FROM EXTRUDED PARISONS

(76) Inventors: Fabrizio Castellari, Bologna (IT); Daniele Bolognesi, Ozzano Dell'Emilia (IT)

Correspondence Address: STITES & HARBISON PLLC, 1199 NORTH FAIRFAX STREET, SUITE 900, ALEXANDRIA, VA, 22314, US

(21) Appl. No.: 12/296,477

(22) PCT Filed: Mar. 22, 2007
(86) PCT No.: PCT/EP2007/052750

§ 371 Date: Oct. 8, 2008

(30) Foreign Application Priority Data
Apr. 12, 2006 (IT) BO2006A000268

(51) Int. Cl. B29C 49/04

(52) U.S. Cl. 425/150

(57) ABSTRACT

The invention describes a machine typically comprising two or four carriages with associated mould/counter-mould (S1, S2) units movable along perpendicular axes, with one mould and counter-mould unit which cyclically is loaded with parisons and is displaced for the container blow-moulding operation, while the other mould and counter-mould unit is prepared for unloading the containers formed during the previous cycle and then insertion into the parison supply station. Each mould/counter-mould unit has, associated with it, a blowing station which follows the unit during the displacement on the associated primary carriage (3), but not during the movement on the secondary carriages (10) for insertion into and extraction from the station with the extrusion head. A centralized pair of grippers is envisaged on the side of each primary carriage and in alignment with the extrusion head and performs extraction of the bottles formed by each mould and counter-mould unit and transfer of the said bottles into the following finishing stations and finally onto the single product exit way.

The present invention relates to machines for producing plastic containers using the technique of blow moulding, said machines being fed by an extruder which continuously produces hot, descending, vertical tubes of thermoplastic material—so-called parisons—a portion of which is cyclically gripped inside the corresponding cavity of a mould and counter-mould unit, is separated from the continuous parison by means of a cutting operation and then, while by means of a suitable vertical relative movement of the mould/counter-mould unit and extruder, continuous operation of the latter is ensured, the same mould/counter-mould unit is transferred into a station where, inside a partially closed end of the said plastic pouches trapped inside it, corresponding nozzles are inserted so as to blow in pressurized gas which causes the said pouches to adhere closely to the cavities of the said mould and counter-mould unit, in order to form the containers with the desired dimensional and shape characteristics. Then, while the containers are retained via the mouth by the nozzles of the blowing unit, the mould and the counter-mould open and return into the parison production station, with the relative arrangement in relation to the extruder necessary for repetition of a new working cycle.

In the prior art, in order to meet the different production requirements, at present various machine models have been developed and this type of solution results in the need to manage the various machine models, with the corresponding spare parts and associated problems. The machines of the known type are currently of the rectilinear type, with working strokes of varying length, with a single or double carriage, or are of the carousel type. This latter type of machine, if on the one hand it offers advantages in terms of productivity compared to the category of rectilinear machines, owing to the possibility of having fixed and unique positions for the label supplying stations, if required, and the unloading stations and a reduced cycle downtime, since, while a mould/counter-mould unit is moved away from the extruder and transferred into the blowing station, a following mould/counter-mould unit may be simultaneously inserted, open, underneath the said extruder, on the other hand this same type of machine has notable problems with regard to maintenance of even only one of the mould/counter-mould units or one of its operating stations, since it requires temporary stoppage of the machine and interruption of the entire production. In this type of machine there also exists the drawback of the difficulty in gaining access to the various workstations and in particular to the extruder and there exist major problems due to the considerable weight and therefore the considerable inertia of the carousel with on-board the various mould and counter-mould units. With these machines it is also impossible to produce containers with a calibrated neck, without resorting to extremely complex and costly solutions. In all the known blow-moulding machines, be they of the rectilinear or the carousel type, when the mould and counter-mould units must be replaced in order to produce containers with a different shape and/or format, it is necessary to stop the machine for the whole period required to carry out the modifications, with the major cost-related problems resulting from this condition.

The invention intends to overcome the drawbacks and shortcomings of the prior art, with a blow-moulding machine of the rectilinear type which is highly flexible and allows operations for maintenance or replacement of one or more of the mould/counter-mould units forming it to be performed while other units remain productively active, with the obvious economic advantages resulting from this condition. In the machine according to the invention, the components are standardized and it is possible to pass from small or medium scale production to large-scale production, by means of the simple addition of some components of the modular type, with all the constructional and functional simplifications resulting from this condition. These and other objects of the invention have been achieved with a machine as claimed in the accompanying Claim 1 and as in the claims hereafter, based on the following proposed solution. The die with the various openings for discharging the parisons is oriented so as to have the said parison discharge openings in a vertical ideal plane which is perpendicular to a horizontal guide which has, sliding along it, by means of the action of an electric motor with electronic speed and phase control, a primary carriage which has, mounted thereon, perpendicularly with respect to the said primary guide and with a mutually parallel arrangement, two guide and slide units with associated secondary carriages on which a respective mould/counter-mould unit is mounted, with the cavities arranged in a vertical plane and parallel to that ideal plane in which the parisons produced by the extruder lie. Respective blowing stations, with their sets of vertically movable nozzles, are mounted on the end of the said primary carriage, above each mould and counter-mould unit. As a result of the displacement imparted to the said primary carriage, one of the secondary carriages with the associated mould and counter-mould may be aligned with the extrusion head and, by means of centralized displacement means, this secondary carriage may be displaced so as to insert the associated mould/counter-mould unit underneath the said extrusion head for loading with corresponding parisons. In phase sequence, this mould/counter-mould unit is moved away from the extrusion head and at the end of the displacement stroke is positioned underneath its blowing station which performs forming of the containers, while the primary carriage is displaced so as to move away the mould/counter-mould unit which is performing forming and replace it with the other mould/counter-mould unit which in synchronism opens and is inserted underneath the extrusion head, while the containers formed in it during the previous cycle remain suspended from the nozzles of the associated blowing station and are gripped by pairs of grippers associated with both the secondary carriages, which make use of the insertion and extraction movement of a secondary carriage into and from the parison extrusion station, in order to transfer the said containers into a following sprue-removal and sizing station and then into an unloading station. The cycle described is repeated with a mould and counter-mould unit which is cyclically loaded with parisons and is displaced for the container blow-moulding step, while the other mould and counter-mould unit is prepared for unloading the containers formed during the previous cycle and then insertion into the parison supply station. By keeping one of the two mould and counter-mould units in alignment with the extrusion station and therefore eliminating the alternating movements of the primary carriage, it is possible to perform maintenance or replacement operations on the inactive carriage, the associated mould/counter-mould unit and the associated blowing station, while the machine continues to operate, albeit with a halved production capacity. It is clear how with the said solution it is possible to adapt the blow-moulding machine to the change in format of the containers to be produced, while the machine itself is in operation, albeit with a lower production capacity, but without long stoppage times as is instead required by the prior art. In order to meet large-scale production requirements, the machine may be provided on the other side of the extrusion head with a double mould and counter-mould unit system, which is a mirror image of the one described above, with the associated primary carriage and guide and slide units and secondary carriages, with associated pairs of blowing stations, with associated pair of grippers and associated sizing, sprue-removal and unloading station, so as to limit the downtime of the operating cycle to only two mould and counter-mould units, since while a mould/counter-mould unit is moved away from the extrusion head, on the opposite side another mould/counter-unit is simultaneously inserted underneath the same extrusion head, ensuring cycle times substantially similar to those of the carousel machines mentioned in the introduction, without, however, the disadvantages characteristic of this type of machine. In the machine version with four carriages there is also the advantage of being able to have two carriages which are always in operation and two of them in the rest position for any necessary maintenance and/or replacement of the mould/counter-mould units and the associated blowing stations, so as to reduce the machine stoppage time when problems arise or when it is required to modify the production of the containers.

Further characteristic features of the invention and the advantages arising therefrom will become clearer from the following description of a preferred embodiment thereof, illustrated purely by way of a non-limiting example in the figures of the accompanying illustrative plates in which:

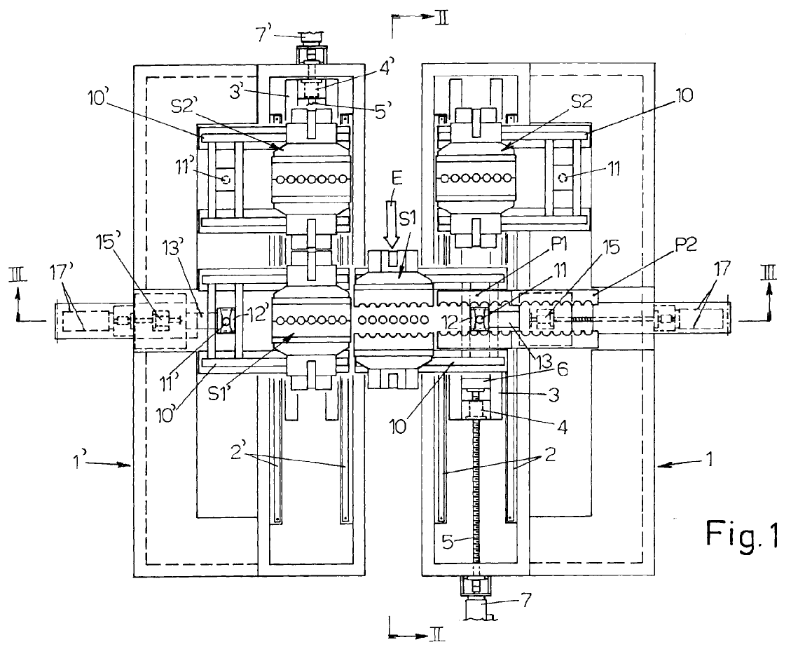

FIG. 1 is a schematic top-plan view of the machine in the more complete high-production version;

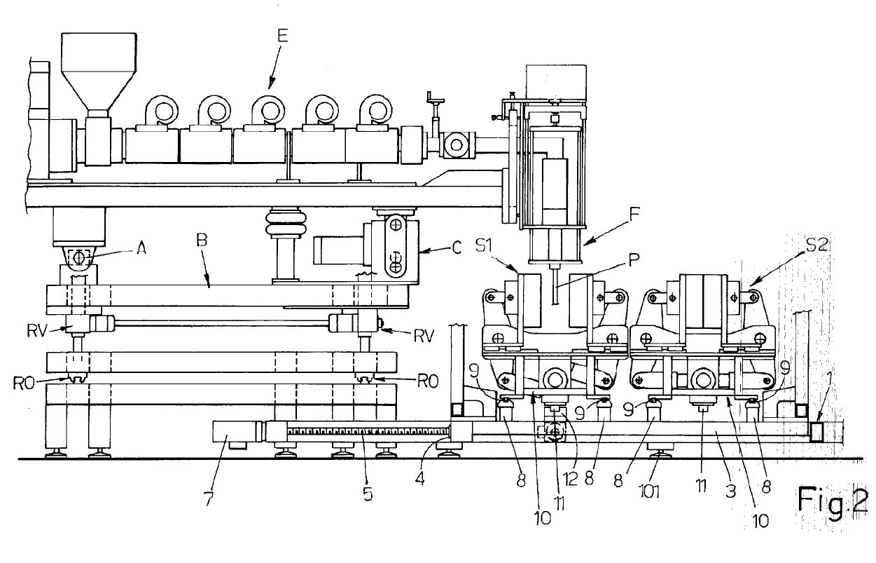

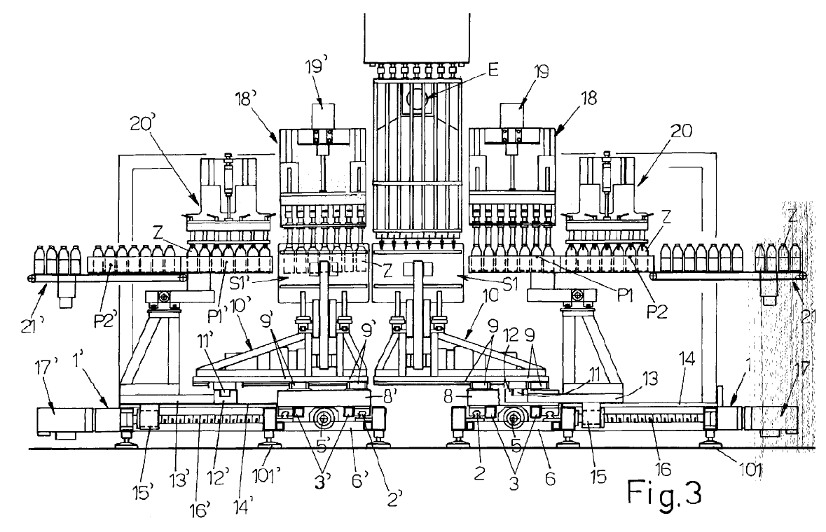

FIGS. 2 and 3 show corresponding details of the machine viewed along the cross-sectional lines II-II and III-III in FIG. 1;

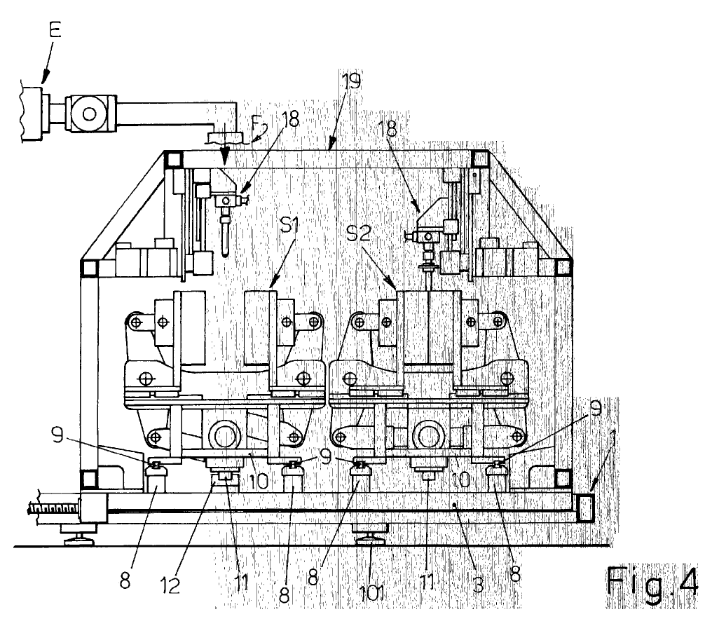

FIG. 4 shows other details of the machine viewed along the same cross-sectional line II-II in FIG. 1.

In the figures, E denotes the extruder which supplies an extrusion die or head F which discharges a plurality of descending parisons P which are positioned coplanar alongside each other, in an ideal vertical plane which is perpendicular to the longitudinal axis of the said extruder which, according to the known art, is hinged with its end opposite to that which carries the head F, on a shaft A parallel to the said row of parisons and supported by a suitable frame B which supports means C, also known, which, upon operation, cause the extruder to pitch along the said hinging axis A, so as to raise or lower the extrusion head F during co-operation with the mould/counter-mould units of the blow-moulding machine. The frame B is provided with both vertical adjustments RV and horizontal adjustments RO so as to be able to be correctly interfaced with the blow-moulding machine.

In the description which follows the machine in the most complete and highest productivity version is shown, with four carriages which operate, in pairs, on either side of the extrusion head F and which, in the drawings, are shown in different operating positions so as to facilitate understanding of the constructional design and operation of the said machine, it nevertheless being understood that the said machine may be provided with only one carriage or with two carriages, in order to meet small or medium scale production requirements, as explained better further below. Laterally with respect to the extruder E, on either side of the latter, support frames 1, 1′ are arranged resting on the ground with their adjustable feet 101, 101′, said frames being for example rectangular in plan view and oriented with their greater dimension parallel to the longitudinal axis of the said extruder E and, along the same dimension, carrying a respective pair of rectilinear and mutually parallel guides 2, 2′, the middle part of which is intersected by the vertical ideal plane on which the row of parisons P which descend from the extrusion head F lies. The said guides 2, 2′, which we shall define as main in order to distinguish them from other guides considered below, have sliding along them with precision, for example via recirculating ball slides, respective main carriages 3, 3′ which are displaced longitudinally by means of precision actuators consisting for example of screw and female nut assemblies, with the female nuts 4, 4′ mounted, for example, on a cross-member of the said carriages and with the screws 5, 5′ which are supported at one end by cross-members 6, 6′ (FIG. 3) situated underneath the guides 2, 2′ so as not to interfere with the said carriages and which with the other end are supported rotatably by an end side of the frame 1, 1′ and, upon operation, are made to rotate by electric motors 7, 7′ rotating in both directions, with brake and electronic speed and phase control, for example brushless motors. Each of the main carriages 3, 3′ have, mounted on them, suitably raised, two pairs of cross-members 8 and 8′ (FIG. 2) on which corresponding secondary carriages 10, 10′ are mounted in a longitudinally slidable manner, via precision guides and slides 9, 9′, said carriages carrying, with the respective self-centring opening and closing drive systems, with displacement in directions parallel to the main guides 2, 2′, respective mould/counter-mould units S1, S2 and S1′,S2′, the cavities of which are situated in vertical ideal planes which are transverse to the said guides 2, 2′ and parallel to the vertical ideal plane along which the rows of parisons P descend from the extrusion head F. From FIGS. 1 and 3 it can be seen that the mould/counter-mould units are positioned on the end of the respective secondary carriages 10, 10′ which is directed towards the extruder, while the same secondary carriages have, on the other end, respective pins 11, 11′ which are oriented downwards and means, not shown, are envisaged for keeping normally the secondary carriages with the associated mould/counter-mould units above the main carriage 3, 3′ and preventing these units from performing undesirable movements. These means may, for example, comprise a fixed and grooved guide inside which the said pins 11, 11′ slide and which is interrupted at the point where respective switch-over devices 12, 12′ operate, said devices being mounted on slides 13, 13′ which travel on guides 14, 14′, aligned with the row of parisons P which descend from the extrusion head F, these slides being situated at a lower height than the secondary carriages 10, 10′ and being able to perform a rectilinear movement towards or away from the extrusion head, by means of respective assemblies comprising female nuts 15, 15′ and screws 16, 16′ which are moved by respective electric motors 17, 17′ with electronic speed and phase control, rotating in both directions and with a brake, for example brushless motors. By means of the action of the aforementioned motors 7, 7′, the mould/counter-mould units S1, S2 and S1′, S2′ may be brought selectively to one end of the main guide 2, 2′ or alongside the extrusion head and, when they reach this latter condition, as shown for the unit S1′ in FIGS. 1 and 3, the pin 11 or 11′ of the secondary carriage 10, 10′ of this unit cooperates with the associated switch-over device 12, 12′ which is in the retracted rest position. In this condition, with operation of the motor 17, as shown for the mould/counter-mould unit S1 in FIGS. 1 and 3, the slide 13 may be moved towards the extrusion head F and inserted between a pair of cross-members 8 in order to displace the secondary carriage 10 projecting from the respective guides 9 and move, with precision, the said unit S1, open, underneath the extrusion head F, for gripping the parisons P discharged from the latter. After the unit S1 has closed and gripped the parisons which by known cutting means have been separated from the extrusion head F, which in the meantime is raised, the motor 17 reverses its rotation and moves the said unit S1 back into the original position where, with a descending movement, the calibrated nozzles of a blowing station 18 associated with this unit S1 intervene for the container forming step. As can be seen from the detail shown in FIGS. 3 and 4, each unit S1 and S2 and S1′, S2′ has, associated with it, respective blowing stations 18, 18′ which are mounted on the gantry structure ends 19, 19′ fixed on the respective primary carriages 3, 3′ and which therefore move with the latter but are not affected by the transverse displacements imparted to the mould/counter-mould units by means of the motors 17, 17′. During the abovementioned backward movement of the unit S1, the mould/counter-mould unit S1′ is inserted open underneath the extrusion head F so as to perform an associated working cycle. In phase sequence, while the blowing station 18 associated with the unit S1 has been activated on this unit and performs forming of the containers therein, the primary carriage 3 is displaced so as to move away the said unit S1 and position laterally with respect to the extrusion head the other unit S2 which opens, as illustrated for the left-hand unit S1′ in FIG. 3, while the containers Z formed therein during the previous working cycle remain suspended from the nozzles of the associated blowing station 18 which remains in the low position. During the next step, while the unit S1′ is moved away from the extrusion head and the right-hand unit S2 is positioned underneath the latter, the containers Z suspended from the nozzles of the blowing head 18 of S2 are gripped by a self-centring gripper P1 mounted with a second gripper P2 on the slide 13, as illustrated in FIG. 3 and in phase sequence, the nozzles of the station 18 of S2 move up and are separated from the containers Z retained by the gripper P1. In phase sequence, when the mould/counter-mould unit S2 is moved away from the extrusion head, the gripper P1 transfers the containers Z into a usual static sprue-removal and sizing station, where the said containers, still retained by the gripper P1, are freed by known means firstly of the top and bottom sprue and are then gripped via the mouth by the sizing pins of the station 20 and remain suspended from the latter when the gripper P1 opens for repetition of a following working cycle during which these containers are gripped by the gripper P2 which, during the subsequent working cycle transfers them onto an unloading line 21.

On the other side, the mould/counter-mould units S1′,S2′ are also served by a respective sprue-removal and sizing station 20′ and by a respective unloading line 21′ and means may be envisaged for collecting the containers unloaded by these lines and conveying them to a single workstation.

It is clear from FIG. 1 how a wide corridor exists between the two platforms 1 and 1′ and allows easy access to the extrusion head F.

The versatility of the machine is also clear since the machine may be provided in the single-carriage version with associated mould/counter-mould unit S1 and already equipped for receiving in the future also the second carriage with the associated mould/counter-mould unit S2, with the associated blowing stations, or may be provided in the version with four carriages with associated mould/counter-mould units S1, S2 and S1′, S2′ and associated blowing stations and with all the apparatus described.

The constructional details relating to the blowing and sprue-removal/sizing stations have been omitted from the description since they are known and are described, for example, in document EP 0950606.

1. Machine for blow-moulding bottles or other containers formed from parisons produced by an extruder, characterized in that it comprises on a special platform a main rectilinear and horizontal guide which is parallel to the longitudinal axis of the extruder and which with its middle part is situated along the side of the extrusion head which discharges the row of parisons perpendicularly with respect to the said guide on which a primary and motor-driven carriage slides, said carriage having, mounted thereon perpendicularly with respect to the said primary guide and with an arrangement parallel to each other, two horizontal guide and slide units with associated secondary carriages on which a respective mould/counter-mould unit may be mounted, with the cavities situated in a vertical plane parallel to the ideal plane of the parisons produced by the extruder and on each of these units there being mounted a blowing station with a set of nozzles vertically movable on a support structure fixed to the said primary carriage, process means being envisaged for ensuring that, by imparting alternating movements to this primary carriage, one of the said secondary carriages with the associated mould/counter-mould unit may be aligned with the extrusion head and, by means of a centralized displacement actuator, this secondary carriage may be displaced so as to insert the associated mould/counter-mould unit underneath the said extrusion head so as to be loaded with corresponding parisons, following which this closed and loaded mould/counter-mould unit is moved away from the extrusion head and at the end of this travel stroke is positioned underneath its blowing station which performs forming of the containers, while the primary carriage is displaced so as to move away the mould/counter-mould unit which is performing the forming step and replace it with the other mould/counter-mould unit which in synchronism is opened and is inserted underneath the extrusion head, while the containers formed in it during the previous cycle remain suspended from the nozzles of the associated blowing station and are gripped and discharged by special means, and means are envisaged for ensuring that the cycle described is repeated with a mould and counter-mould unit which is cyclically loaded with parisons and is displaced for the container blow-moulding step, while the other mould and counter-mould unit is prepared for unloading the containers formed during the previous cycle and then insertion inside the parison supply station.

2. Machine according to claim 1, in which the means which perform unloading of the containers from the mould and counter-mould unit which is cyclically positioned alongside the extrusion head comprise two pairs of self-centering grippers which make use of the rectilinear insertion and extraction movement of a second carriage underneath the parison extrusion head, in order to transfer the said containers into a downstream sprue-removal and sizing station and then into an unloading station, this pair of grippers being associated with both the mould and counter-mould units of the secondary carriages so as to have a single exit way for the bottles produced by the two mould and counter-mould units.

3. Machine according to claim 1, characterized in that, in order to meet the need for large-scale production of containers, the machine itself may be provided on the other side of the extrusion head and of an extruder with a second system comprising a double mould and counter-mould unit, which is a mirror image of that provided on the other side of the said extruder, with the associated motor-driven primary carriage and guide and slide units with secondary carriages, with associated transverse displacement actuator and with associated pairs of blowing stations, with associated pair of self-centering grippers and associated sprue-removal and sizing station and unloading station, so as to limit the downtime of the operating cycle to only two mould and counter-mould units since, while a mould/counter-mould unit is moved away from the extrusion head, on the opposite side another mould/counter-mould unit is simultaneously inserted underneath the said extrusion head, ensuring cycle times which are similar to those of carousel machines, without, however, the disadvantages which are characteristic of this type of machine.

4. Machine according to claim 1, in which the primary carriage or carriages and the actuator which, upon operation, inserts and extracts a secondary carriage with the associated mould/counter-mould unit underneath or from the extrusion head are actuated by respective precision systems, for example of the type comprising screw and female nut controlled by respective electric precision motors rotating in both directions, with brake and electronic speed and phase control, for example brushless motors.

5. Machine according to claim 1, in which the mould/counter-mould units are situated on the end of the respective secondary carriages which is directed towards the extruder, while the said secondary carriages have on the other end respective pins which are oriented downwards and means are envisaged for keeping normally the secondary carriages with the associated mould/counter-mould units above the main carriage so as to prevent these units performing undesirable movements and these means being interrupted at the point where respective U-shaped switch-over devices operate, which devices are engaged by the said pins and are mounted on slides which slide on guides aligned with the row of parisons which descend from the extrusion heads and these slides being positioned at a lower height than that of the said secondary carriages and being designed so as to be able to perform a rectilinear movement towards or away from the extrusion head, by means of respective units of the type comprising female nuts and screws which are moved by respective electric motors for example of the brushless type, so as to impart selectively to the secondary carriages the transverse movement for insertion and extraction underneath or from the parison extrusion head.
